(19) United States
(12) Patent Application Publication
(10) Pub. No.: US 2025/0260486 A1
(43) Pub. Date: Aug. 14, 2025

(54) CALIBRATION OVER ASYMMETRIC LINKS

(71) Applicant: Telefonaktiebolaget LM Ericsson (publ), Stockholm (SE)

(72) Inventors: Stefano RUFFINI, Pisa (IT); Paolo DEBENEDETTI, Genova (IT); Fabio CAVALIERE, Pisa (IT)

(21) Appl. No.: 19/116,268

(22) PCT Filed: Sep. 28, 2022
(86) PCT No.: PCT/EP2022/076965

§ 371 Date: Mar. 27, 2025

(51) Int. Cl. H04B 10/077; H04J 3/06; H04J 14/08

(52) U.S. Cl. CPC H04B 10/0773; H04J 3/0667; H04J 14/08

(57) ABSTRACT

A first transceiver communicatively coupled to a second transceiver by a first cable and a second cable can transmit a first message to the second transceiver at a first time, T₁, via the first cable. The first transceiver can further receive a second message from the second transceiver via the second cable. The second message includes an indication of a second time, T₂, and an indication of a third time, T₃, associated with when a pulse that is associated with the second message was transmitted by the second transceiver. The first transceiver can further receive the pulse associated with the second message from the second transceiver at a fourth time, T₄, via the first cable. The first transceiver can further determine a first delay associated with the first cable based on the T₁, the T₂, the T₃, and the T₄.

### TECHNICAL FIELD

The present disclosure is related to wireless communication systems and more particularly to automatic precise time protocol (“PTP”) calibration over asymmetric links.

### BACKGROUND

FIG. 1 illustrates an example of a new radio (“NR”) network (e.g., a 5th Generation (“5G”) network) including a 5G core (“5GC”) network 130, network node 120 (e.g., 5G base station (“gNB”)), and a communication device 110 (also referred to as user equipment (“UE”)). In some examples, the network node 120 is communicatively coupled with the communication device 110 and/or the core network 130 via a wired connection (e.g., optical fiber).

Optical communication can support 5G and future 6th Generation (“6G”) mobile networks, which can require a high precision of synchronization for fronthaul and backhaul traffic of radio access network (“RAN”) transport networks. Support for precise time protocol (“PTP”) is a standard requirement for any Fronthaul network in particular when dealing with 4th Generation (“4G”) and 5G time division duplex (“TDD”) since the network nodes can require very precise synchronization (e.g., up to nanosecond precision).

Wavelength division multiplexing (“WDM”) technology can be used to carry traffic over fiber infrastructure with scarce availability of fibers.

Timing protocols rely on symmetric communication systems. In some examples, when delivering time information via timing protocols it can be important to estimate the time it takes for a timing message to be delivered from a synchronization master to a synchronization receiver. A round trip time (“RTT”) can be calculated and divided by 2 to get the one-way delay. However, any asymmetry between optical fibers can add errors to this estimation.

### SUMMARY

According to some embodiments, a method of operating a first transceiver communicatively coupled to a second transceiver by a first cable and a second cable is provided. The method includes transmitting a first message to the second transceiver at a first time, T₁, via the first cable. The method further includes receiving a second message from the second transceiver via the second cable. The second message includes an indication of a second time, T₂, and an indication of a third time, T₃, associated with when a pulse associated with the second message was transmitted by the second transceiver. The method further includes receiving the pulse associated with the second message from the second transceiver at a fourth time, T₄, via the first cable. The method further includes determining a first delay associated with the first cable based on the T₁, the T₂, the T₃, and the T₄.

According to other embodiments, a method of operating a first transceiver communicatively coupled to a second transceiver by a first cable and a second cable is provided. The method includes transmitting a first message and an associated first pulse to the second transceiver at a first time, T₁, via the first cable. The method further includes receiving an indication of a second time, T₂, associated with when the first pulse was detected by the second transceiver. The method further includes transmitting a third message and an associated second pulse to the second transceiver at a third time, T₃, via the second cable. The method further includes receiving an indication of a fourth time, T₄, associated with when the second pulse was detected by the second transceiver. The method further includes determining a difference between a first delay associated with the first cable and a second delay associated with the second cable based on the T₁, the T₂, the T₃, and the T₄.

According to other embodiments, a method of operating a first transceiver communicatively coupled to a second transceiver by a first cable and a second cable is provided. The method includes receiving a first message from the second transceiver via the first cable. The first message includes an indication of a first time, T₁, associated with when the first message was transmitted by the second transceiver. The method further includes determining a second time, T₂, at which the first pulse was detected. The method further includes transmitting a second message to the second transceiver via the second cable at a third time, T₃, the second message including an indication of the T₂ and the T₃. The method further includes transmitting a second pulse to the second transceiver via the first cable at the T₃.

According to other embodiments, a method of operating a first transceiver communicatively coupled to a second transceiver by a first cable and a second cable is provided. The method includes receiving a first pulse from the second transceiver via the first cable. The first pulse can include an indication of a first time, T₁, associated with when the first pulse was transmitted by the second transceiver. The method can further include determining a second time, T₂, at which the first pulse was detected. The method can further include receiving a second pulse from the second transceiver via the second cable. The second pulse including an indication of a third time, T₃, associated with when the second pulse was transmitted by the second transceiver. The method can further include determining a fourth time, T₄, at which the second pulse was detected. The method can further include determining a difference between a first delay associated with the first cable and a second delay associated with the second cable based on the T₁, the T₂, the T₃, and the T₄.

According to other embodiments, a first transceiver, a computer program, a computer program product, or a non-transitory computer readable medium is provided to perform one of the methods above.

Certain embodiments may provide one or more of the following technical advantages. In some embodiments, differential delay impairment can be monitored without impacting traffic and without adding any additional instrument for delay measurement. In some examples, the innovations can be added as part of a transceiver design without major cost penalties and allow for the auto-calibration of 25 GHz and beyond links with PTP support for mobile network applications.

In additional or alternative embodiments, each transceiver can calculate the end-to-end differential delay due to the different crossed fibers. A sync pulse can be propagated within the same spectrum used for PTP and payload traffic and can traverse the same optical path. In some examples, the usage of sync pulses without impacting PTP protocols is backwards compatible with prior-art technology and may not require any change to standardized PTP protocols.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a schematic diagram illustrating an example of a 5^{th} generation (“5G”) network;

FIG. 2 is a block diagram illustrating an example of a first transceiver communicatively coupled to a second transceiver in accordance with some embodiments;

FIG. 3 is a schematic diagram illustrating an example of a first transceiver communicatively coupled to a second transceiver via asymmetric paths in accordance with some embodiments;

FIGS. 4-5 are schematic diagrams illustrating examples of signal flows between the first transceiver and second transceiver of FIG. 3 to determine the asymmetry in accordance with some embodiments;

FIG. 6 is a block diagram illustrating an example of superimposing a frequency pulse onto an amplitude modulated signal using a phase optical modulator in accordance with some embodiments;

FIGS. 7-8 are diagrams illustrating an example of superimposing a pulse onto an amplitude modulated signal using a chirp generated by a directly modulated laser in accordance with some embodiments;

FIG. 9 is a diagram illustrating an example of a pulse superimposed onto an amplitude modulated signal in accordance with some embodiments;

FIG. 10 is a block diagram illustrating an example of a pulse being separated from an amplitude modulated signal at a transceiver in accordance with some embodiments;

FIG. 11 is a block diagram illustrating an example of splitters/circulators being used by the first transceiver and the second transceiver of FIG. 3 in accordance with some embodiments;

FIGS. 12-15 are flow charts illustrating examples of operations performed by a first transceiver to determine asymmetry between a communication path between the first transceiver and a second transceiver in accordance with some embodiments;

FIG. 16 is a block diagram of a communication system in accordance with some embodiments;

FIG. 17 is a block diagram of a user equipment in accordance with some embodiments;

FIG. 18 is a block diagram of a network node in accordance with some embodiments;

FIG. 19 is a block diagram of a host computer communicating with a user equipment in accordance with some embodiments;

FIG. 20 is a block diagram of a virtualization environment in accordance with some embodiments; and

FIG. 21 is a block diagram of a host computer communicating via a base station with a user equipment over a partially wireless connection in accordance with some embodiments in accordance with some embodiments.

### DETAILED DESCRIPTION

Some of the embodiments contemplated herein will now be described more fully with reference to the accompanying drawings. Embodiments are provided by way of example to convey the scope of the subject matter to those skilled in the art, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

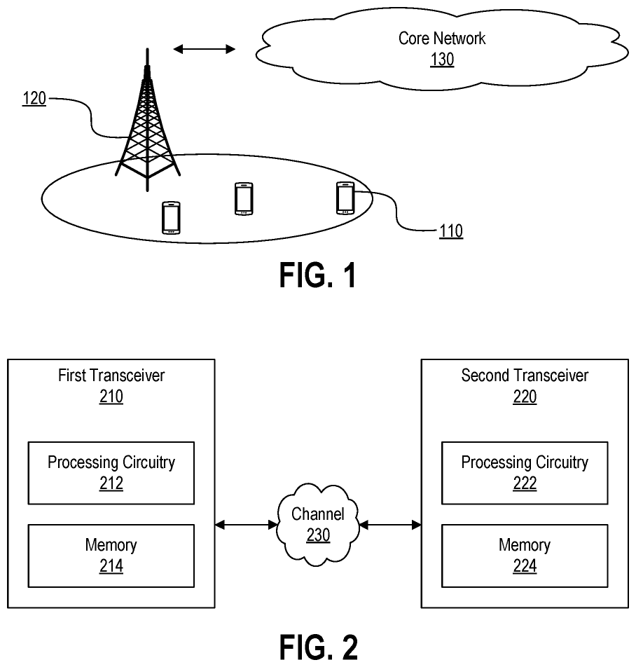

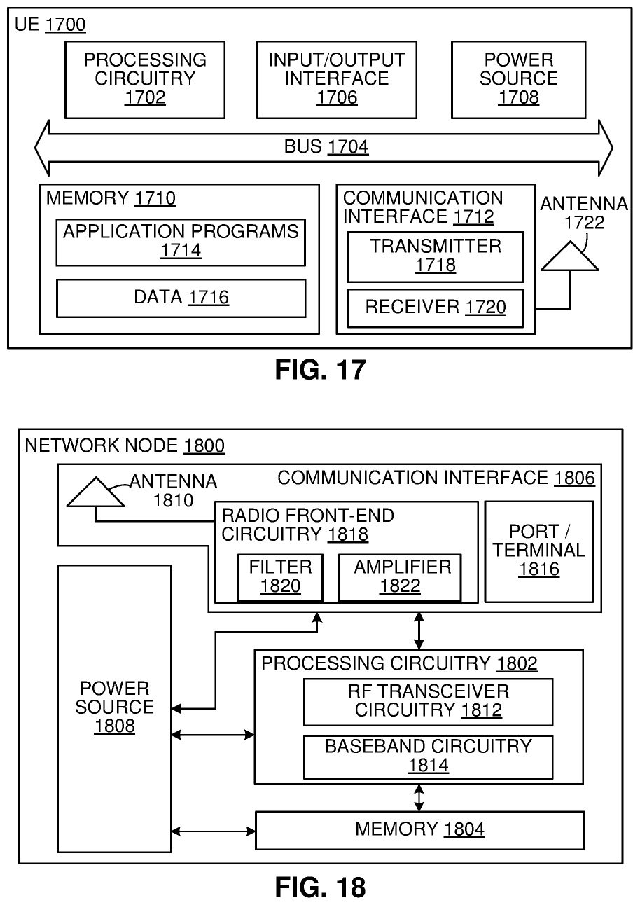

FIG. 2 illustrates an example of a first transceiver 210 communicatively coupled to a second transceiver 220 via a channel 230. Each of the first transceiver 210 and the second transceiver can be included in the core network 130, network node 120, or communication device 110 of FIG. 1 (as well as the UE 1700 of FIG. 17 or network node 1800 of FIG. 18). The channel 230 can be a wireless channel or a wired channel (e.g., via copper wires or optical fibers). The transmitter 210 includes processing circuitry 212 and memory 214. The memory 214 can include instructions stored therein that are executable by the processing circuitry 212 to cause the first transceiver 210 to perform operations including communicating with the second transceiver 220. In some examples, the operations further include determining an asymmetry between communication paths between the first transceiver 210 and the second transceiver 220. The receiver 220 includes processing circuitry 222 and memory 224. The memory 224 can include instructions stored therein that are executable by the processing circuitry 222 to cause the receiver 220 to perform operations including communicating with the second transceiver 220. In some examples, the operations further include determining an asymmetry between communication paths between the first transceiver 210 and the second transceiver 220.

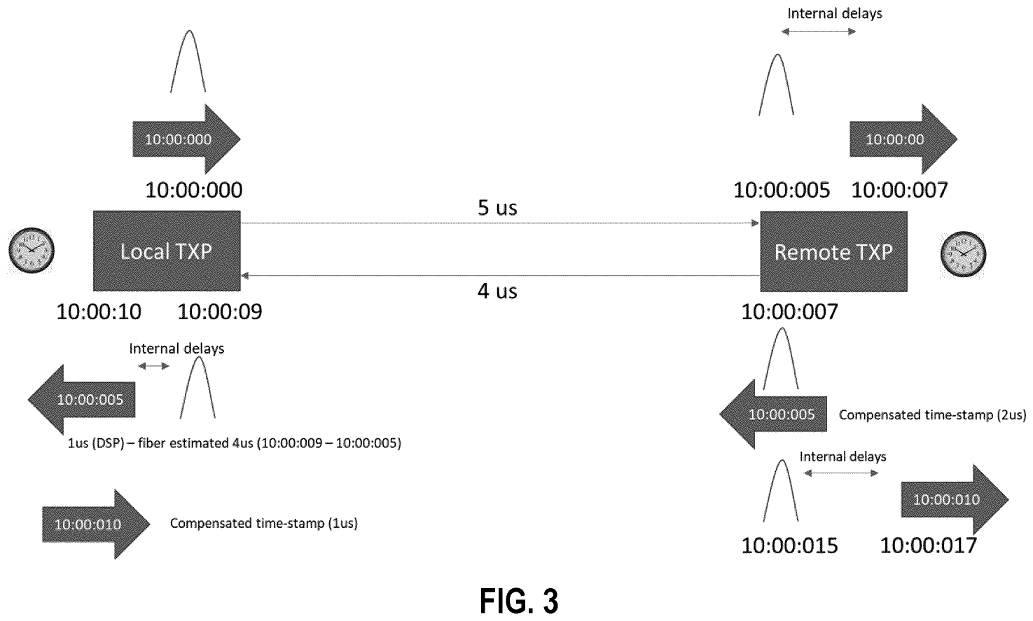

FIG. 3 illustrates an example of communication between a first transceiver (here a local transceiver) and a second transceiver (here a remote transceiver) over a pair of cables (here a first fiber and a second fiber). In this example, a sync pulse is inserted over an optical channel, without affecting the receiver operations and without requiring any change to existing timing protocol messages. In this example, the sync pulse is transmitted over the first fiber. Note that the optical sync pulse, described in more detail below, is not the same as the PTP sync message.

The sync pulse is associated with a timing message (e.g., a message carrying or associated with a specific timestamp T_{L1} generated by the Clock of the local transceiver). For example, the association of the sync pulse and timing message comprises that the optical sync pulse is transmitted at the same time as the timing message (e.g. timing protocol message). Any timing protocol (e.g., precision time protocol (“PTP”)) can be used for this measurement. For example, the timing protocol (e.g. PTP) provides for a two-way average delay experienced by the timing messages. In some cases, the two-way delay measurement uses both the first and second optical fiber, e.g. the timing protocol uses a timing message from the local transceiver to the remote transceiver on the first optical fiber and a further timing message from the remote transceiver to the local transceiver on the second optical fiber. As such, the timing protocol provides an average of the delays of the two transmission directions.

The detection of the sync pulse at the remote transceiver determines a timestamp (T_{R2}) from the remote clock. In some examples, the timestamp (T_{R2}) from the remote clock alternatively corresponds to the detection of the timing message at the remote transceiver.

In some examples, a second optical sync pulse is sent on the same fiber from the remote transceiver to the local transceiver at a time T_{R3}, i.e. the first fiber. In some examples, the second optical sync pulse is associated with a timing message (e.g. also transmitted at a time T_{R3}). In some examples, the timing message is sent on the second fiber (from the remote transceiver to the local transceiver). The sync pulse is received by the local transceiver at a time T_{L4}. In some examples, the timing message transmitted from the remote transceiver to the local transceiver carries timing information, e.g. the value of the timestamp T_{R2} and/or timestamp T_{R3}. The timing message carrying the information may be in an initial timing message, e.g. transmitted at the same time as the timing message (e.g. time T_{R3}) or may be in a later message from the timing protocol, e.g. a PTP follow-up message. References to a message may refer to a single message used for both timing (e.g. determining T_{R4}) and carrying timing information (e.g. timestamp T_{R3}). Alternatively, a reference to a message may refer to two separate messages, e.g. a timing message (e.g. a sync message determining T_{R4}) and a follow-up message carrying timing information (e.g. timestamp T_{R3}).

The delay/length of the first fiber can be evaluated, e.g. by the local transceiver, as:

$${D}_{1} = [ ( {T}_{L 4} - {T}_{L 1} ) - ( {T}_{R 3} - {T}_{R 2} ) ] / 2$$

A similar process can be implemented on the second fiber, allowing an estimate of the delay/length of the second fiber, D₂. To be determined as:

$${{{{{D}_{2} = [ ( T ’}_{L 4} - T ’}_{L 1} ) - ( T ’}_{R 3} - T ’}_{R 2} ) ] / 2$$

In this example, T′_{L1} is a time at which the sync pulse is transmitted from the local transceiver to the remote transceiver via the second fiber. T′_{R2} is the time that the pulse is detected by the remote transceiver. T′_{R3} is the time the remote transceiver transmits a second optical sync pulse back to the local transceiver via the second fiber. T′_{L4} is the time at which the local transceiver detects the pulse sent from the remote transceiver along the second fiber.

The delay/length of the first fiber and the second fiber can be used to find an asymmetry (A) between the communication paths based on:

$$A = {D}_{2} - {D}_{1}$$

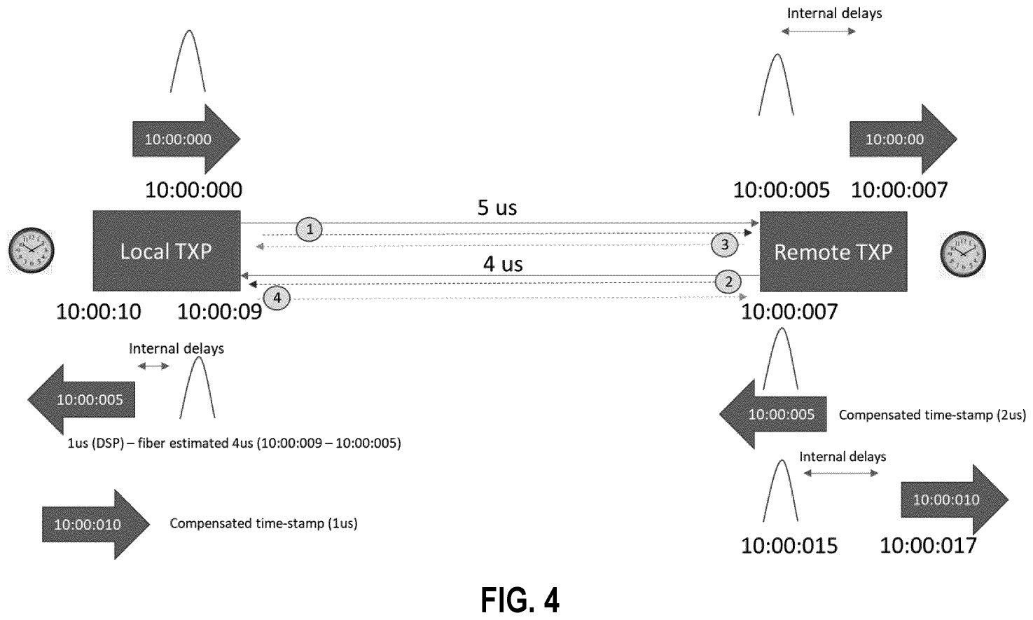

The logical sequence of the signals (pulses) sent over the fibers is shown in FIG. 4. First, the pair of pulses, labelled as 1 and 2, are transmitted on a first optical fiber (with related timestamps T_{L1}, T_{R2}, T_{R3}, and T_{L4}). Optionally, also a further pair of pulses 3 and 4 (with related timestamps T′_{R1}, T′_{L2}, T′_{L3}, and T′_{R4}). These are examples, and different directions and measurements of timestamps may be used.

In any example, the asymmetry impacting the timing protocol (e.g. PTP) may be due to one or more of: Fiber propagation asymmetry, DSP Processing time, and Remote Clock Offset. The measurement of the optical sync pulse(s) can determine one or more of these asymmetry factors.

Other possible mathematical expressions are possible. In some embodiments, having the systems synchronized allows for asymmetry to be determined by the remote transceiver (e.g., without the remote transceiver transmitting return pulses). Instead, the local transceiver transmits a pulse from the local transceiver to the remote transceiver on a first fiber with a related timestamps T_{L1} (instant at the time of transmission from the local clock) and on a second fiber with a related timestamp T′_{L1} (instant at the time of transmission from the local clock). The remote transceiver can determine T_{R2} (when the pulse is received via the first fiber) and T′_{R2} (when the pulse is received via the second fiber).

FIG. 4 shows the complete method with the sync pulses sent in either direction over the same fiber, calculating the actual Fiber Propagation delay without the asymmetric DSP Processing and the Remote Clock Offset.

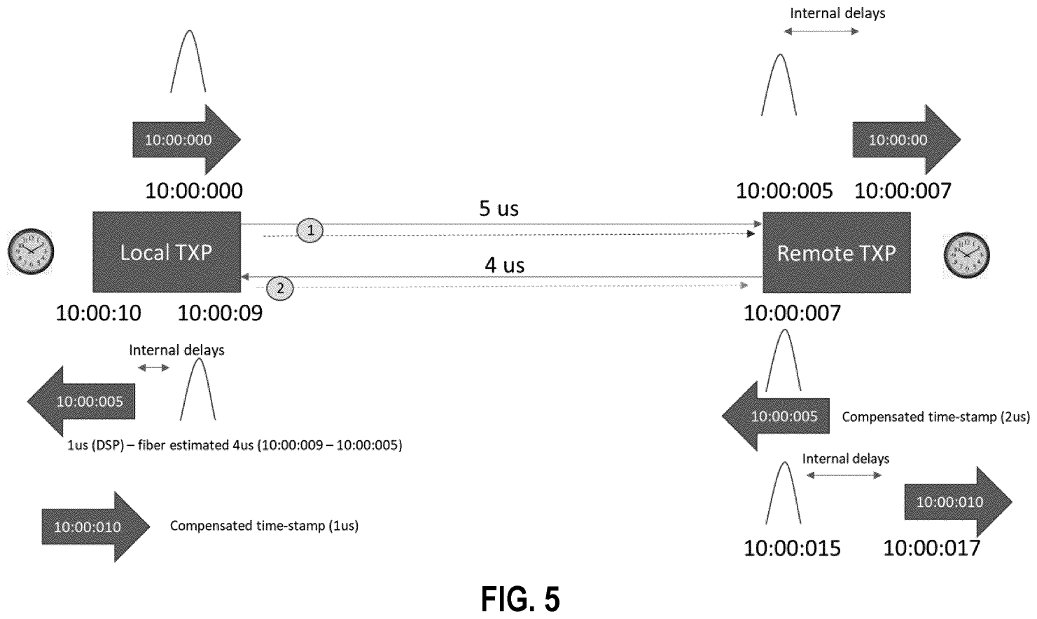

The logical sequence of the signals (pulses) sent over the fibers is shown in FIG. 5. FIG. 5 shows a simplified method where the two end points (transceivers) are already tuned to the same frequency (synchronized) so the optical sync pulses can be used over a single fiber.

In this example, the method comprises sending a first pulse (labelled as Pulse 1, with related timestamps T_{L1} and T_{R2}), and then a second pulse, labelled as Pulse 2, with related timestamps T′_{L1} and T′_{R2}).

The asymmetry can be calculated as follows:

$${{A = ( T ’}_{R 2} - {T}_{R 2} ) - ( T ’}_{L 1} - {T}_{L 1} )$$

Using this method, each transceiver can calculate the differential delay to be compensated due to the different crossed fibers.

In a further example, a time delay of a single optical pulse is used to determine an asymmetry and/or delay between the local transceiver and remote transceiver. For example, the timing of a single optical pulse provides the time delay in one direction, e.g. from the remote transceiver to the local transceiver. The single optical pulse may be transmitted with an associated timing message, e.g. transmitted at the same time as the timing message. The time measured by the optical pulse can be used in a calculation with the average two-way time obtained from the two-way timing protocol (e.g. PTP) to determine the delay in each direction. For example, the delay on the optical fiber not used for the optical pulse equals the total delay due to the optical fibers from the two-way timing measurement minus the delay measured by the optical pulse. is the Thus, the asymmetry can be calculated. Delays due to processing delays can be assumed to be equal at each transceiver or measured in another way.

In some examples, a time reference can be sent by superimposing a frequency pulse (e.g., a sudden variation of the optical carrier frequency) to the transmitted intensity-modulated (e.g., OOK or PAM4) optical signal. This has an advantage of not penalizing the received signal, since the photodiode used to receive in a direct detection system is only sensitive to the input signal amplitude and not to its phase.

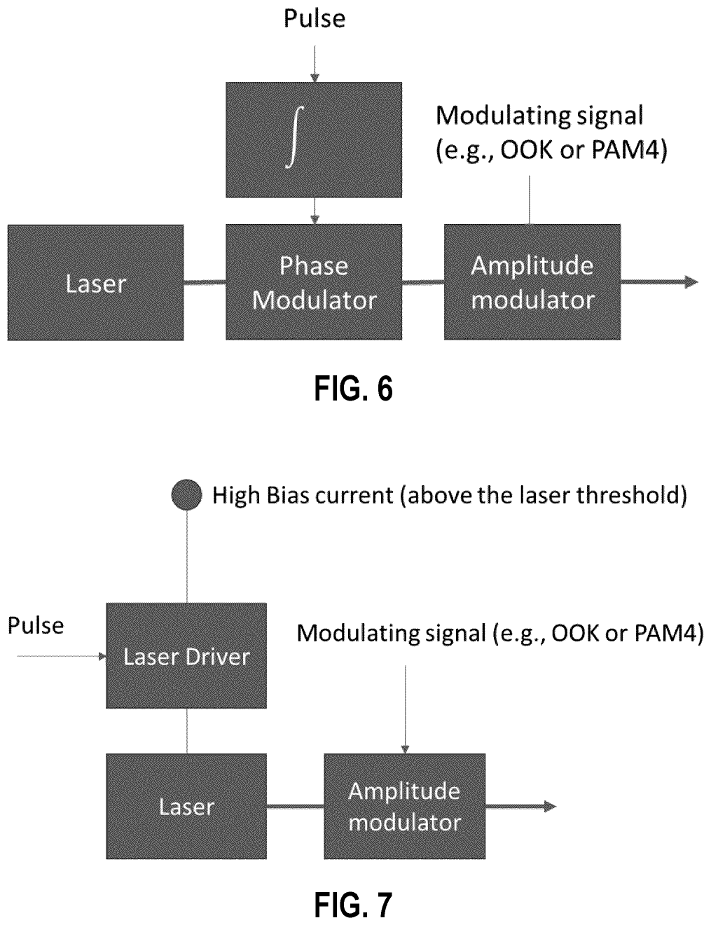

FIGS. 6-7 illustrate two different ways to superimpose a frequency pulse (or, in general, a frequency modulation) to an amplitude modulated signal.

FIG. 6 illustrates an example of superimposing a frequency pulse by applying it using a phase optical modulator, independent of the amplitude modulator used for the data. The frequency, f, is the derivative of the phase, Φ, f=½π·dΦ/dt, the pulse can be integrated before being modulated. In some examples, the phase and amplitude modulator can be monolithically integrated on the same photonic integrated circuit (“PIC”) (e.g., a silicon photonic circuit). In other examples, the phase modulator and the amplitude modulator can be implemented separately.

By directly applying the pulse to the phase modulator, two spikes of frequency of opposite sign in correspondence to the pulse edge are obtained, which can be used to detect the time stamp on the ramp-up and ramp-down of the integrated pulse.

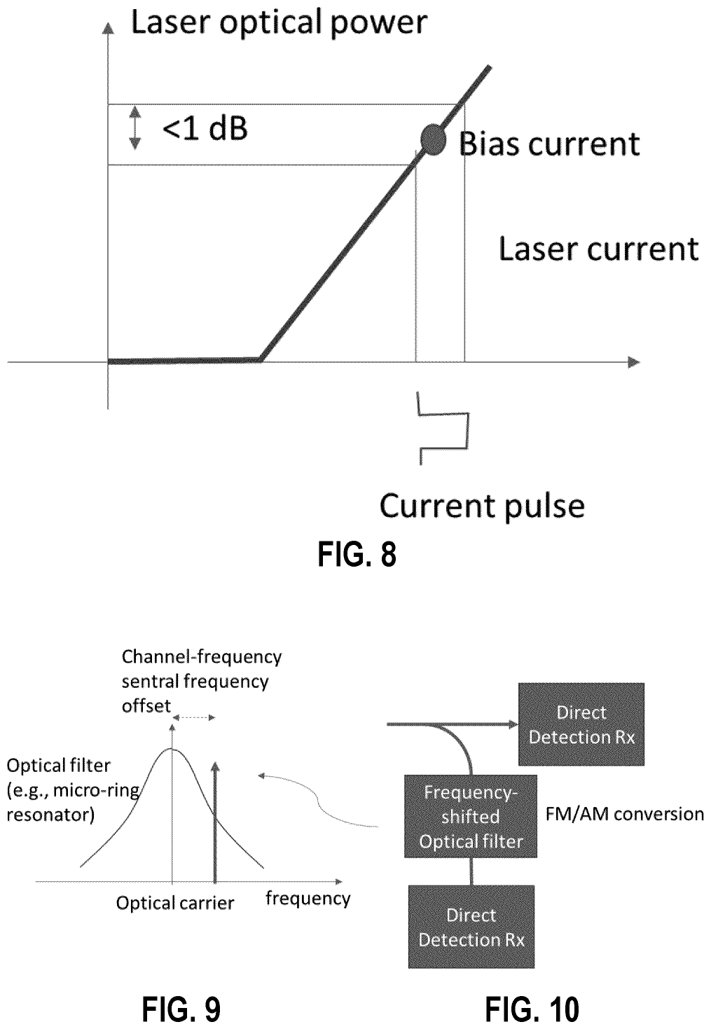

FIGS. 7-8 illustrates an example of superimposing a frequency pulse without an additional phase modulator and relies instead on a chirp generated by a directly modulated laser. In some embodiments, a high bias current, far from the lasing threshold, is applied to the laser and a current pulse is superimposed by means of a laser driver.

The pulse amplitude can be small, to keep small the corresponding output power variation (e.g., within an extinction ratio, r, of 1 dB), which would disturb the data signal. With a high bias current even small amplitude variations give significant power variations.

The frequency variation due to the chirp is given by the equation below:

$$f ( t ) = \frac{α}{4 π} ( \frac{1}{P ( t )} \frac{dP ( t )}{dt} + kP ( t ) )$$

The first term, referred to as a transient chirp, is associated to the variations of the optical power. The second term is proportional to the optical power and is referred to as an adiabatic chirp.

The first term can be dominant when the laser is biased close to the threshold and the power difference between the low and high levels of the transmitted pulses is high, as happens in regular OOK transmissions. The adiabatic chirp dominates instead in these working conditions (high output power and small power variation) so that:

$$f ( t ) \approx \frac{α kP ( t )}{4 π}$$

The high and low levels of the pulse, P₁ and P₀ respectively, obey to the following equations:

$${P}_{bias} = ( {P}_{1} + {P}_{0} ) / 2 and r = {P}_{1} / {P}_{0} ,$$

where P_{bias} and r are the average output power and the extinction ratio, respectively. Using these equations, we obtain the frequency deviation Df associated to the pulse:

$$Df \approx \frac{α k ( {P}_{1} - {P}_{0} )}{4 π} = \frac{α k}{2 π} {P}_{bias} \frac{r ( r - 1 )}{r + 1}$$

Considering a=2.8, k=11.4 GHz/mW, P_{bias}=3 mW Error! Reference source not found., r=1 dB (i.e. 1.26 in linear units), Df=2 GHZ. The laser can be designed such that higher frequency deviations can be obtained.

At the receiver the photodiode cannot detect the signal frequency. FIGS. 9-10 illustrate that a frequency modulated signal can be converted into an amplitude modulated signal using filter detuned with respect to the optical carrier.

Since the optical carrier is centered on the slope of the filter, any change of its frequency leads to an amplitude variation.

Even if the received signal is tapped for detecting the frequency pulse, it introduces negligible insertion loss on the main signal path. The insertion loss is instead significant on the path used for the frequency pulse detection, due to the splitting ratio and the filter insertion loss. This is not an issue since the receiver only needs to detect the presence of the pulse and does not have demanding performance requirements for digital detection. The direct detect receiver on the tap line has a bandwidth much lower than the signal bandwidth (e.g., 2 GHz for a 25 Gbit/s signal) so that most of the signal spectrum is filtered out and the one in the receiver narrow bandwidth can be considered as tolerable additive white noise.

The transmission of the pulse co-directional with the traffic can be implemented seamlessly while different embodiments can be adopted for the contra-directional propagation.

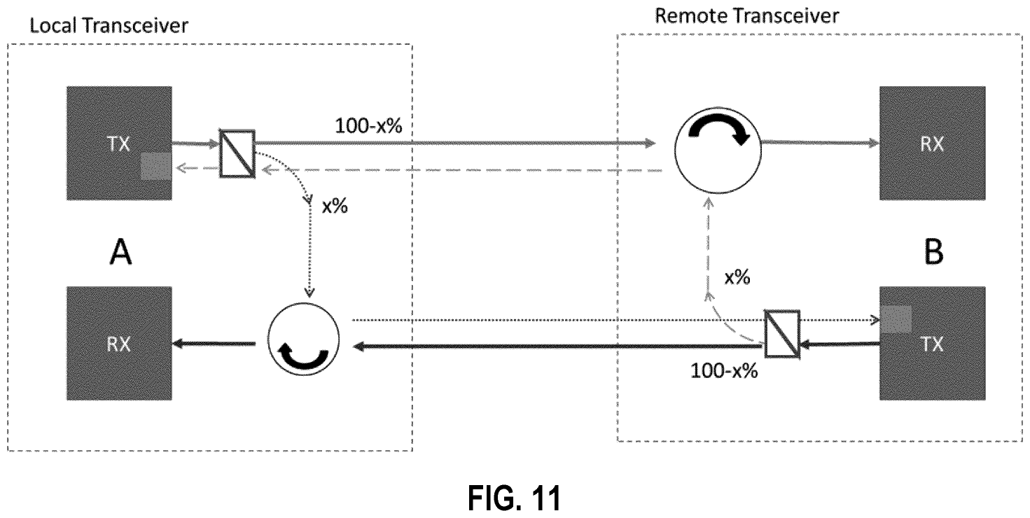

FIG. 11 illustrates an example of a splitter/circulator implemented at each of the local transceiver and remote transceiver in order to inject the modulated pulse to the remote site and a photodiode detector. In some examples, these additions can also provide reflection monitoring and local loop monitoring.

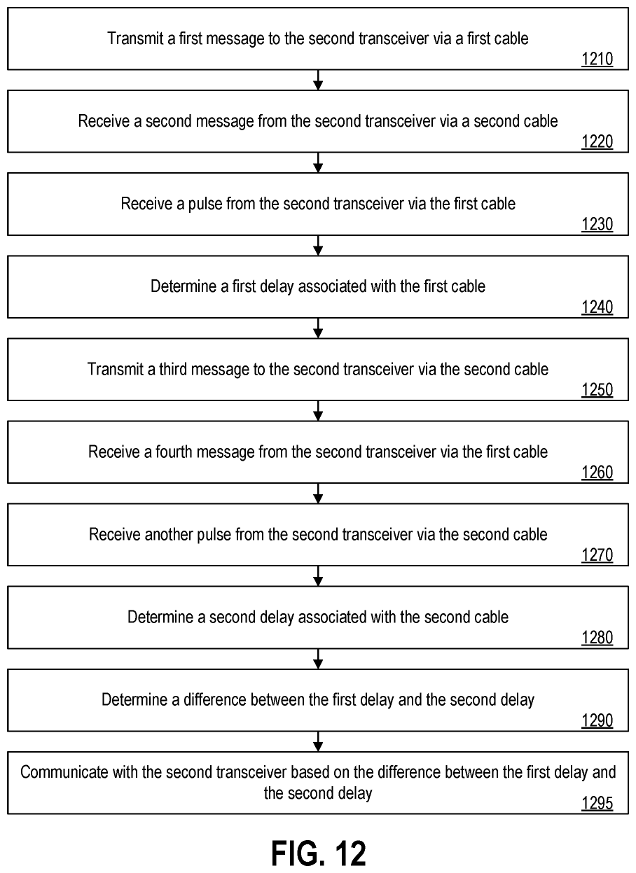

In the description that follows, while the first transceiver may be any of communication device 110, network node 120, first transceiver 210, second transceiver 220, wireless device 1612A-B, wired or wireless devices UE 1612C-D, UE 1700, Hub 1614, network node 1610A-B, core network node 1608, network node 1800, virtualization hardware 2004, virtual machines 2008A, 2008B, network node 2104, or UE 2106, the first transceiver 210 shall be used to describe the functionality of the operations of the first transceiver. Operations of the first transceiver 210 (implemented using the structure of the block diagram of FIG. 2) will now be discussed with reference to the flow charts of FIGS. 12-15 according to some embodiments of inventive concepts. For example, modules may be stored in memory 214 of FIG. 2, and these modules may provide instructions so that when the instructions of a module are executed by respective first transceiver processing circuitry 212, processing circuitry 212 performs respective operations of the flow charts.

FIG. 12 illustrates an example of operations performed by a first transceiver communicatively coupled to a second transceiver by a first cable and a second cable.

At block 1210, processing circuitry 212 transmits a first message to the second transceiver at a first time, T₁, via the first cable. In some embodiments, transmitting the first message includes transmitting the first message and an associated first pulse at the T₁ via the first cable. In some examples transmitting the first message and the associated first pulse includes: (1) generating an amplitude modulated signal including data associated with the first message using an amplitude modulator; (2) generating a transmit signal by superimposing the first pulse on the amplitude modulated signal using a phase optical modulator independent of the amplitude modulator; and (3) transmitting the transmit signal.

In additional or alternative embodiments, transmitting the first message and the associated first pulse includes: (1) applying the first pulse and a bias current that is above a laser threshold to a laser driver; (2) generating an optical signal by a laser using the laser driver; (3) generating a transmit signal by amplitude modulating the optical signal based on data associated with the first message; and (4) transmitting the transmit signal.

At block 1220, processing circuitry 212 receiving a second message from the second transceiver via the second cable. The second message can include an indication of a second time, T₂, and an indication of a third time, T₃, associated with when a pulse (sometimes referred to as a second pulse) that is associated with the second message was transmitted by the second transceiver. In some examples, the second time T₂ is a time associated with when the first message was detected by the second transceiver. In additional or alternative examples, the second time T₂ is a time associated with when the first optical pulse (associated with the first message) was detected by the second transceiver.

At block 1230, processing circuitry 212 receives a second pulse from the second transceiver at a fourth time, T₄, via the first cable.

At block 1240, processing circuitry 212 determines a first delay associated with the first cable based on the T₁, the T₂, the T₃, and the T₄. In some embodiments, determining the first delay associated with the first cable includes determining the first delay, D₁, based on D₁=[(T₄−T₁)−(T₃−T₂)]/2.

At block 1250, processing circuitry 212 transmits a third message to the second transceiver at a fifth time, T₅, via the second cable. In some embodiments, the third message (and, in some examples, the associated third pulse) are transmitted in a process similar to the first message (and the first pulse) in block 1210.

At block 1260, processing circuitry 212 receives a fourth message from the second transceiver via the first cable. The fourth message can include an indication of a sixth time, T₆, and an indication of a seventh time, T₇, associated with when a fourth pulse that is associated with the fourth message was transmitted by the second transceiver.

At block 1270, processing circuitry 212 receives the fourth pulse associated with the fourth message from the second transceiver at an eighth time, T′_{L4}, via the second cable.

At block 1280, processing circuitry 212 determines a second delay associated with the second cable based on the T₅, the T₆, the T₇, and the T₈. In some embodiments, determining the second delay associated with the second cable includes determining the second delay, D₂, based on D₂=[(T₈−T₅)−(T₇−T₆)]/2.

At block 1290, processing circuitry 212 determines a difference between the first delay and the second delay. In some embodiments, determining the difference between the first delay and the second delay includes determining an asymmetry between at least one of: a first length of the first cable and a second length of the second cable; a first digital signal processing (“DSP”) time of the first transceiver and a second DSP time of the second transceiver; and a first application-specific integrated circuitry (“ASIC”) processing time on the first transceiver and a second ASIC processing time of the second transceiver.

At block 1295, processing circuitry 212 communicates with the second transceiver based on the difference between the first delay and the second delay. In some embodiments, the messages (e.g., the first message and the second message) are each precise time protocol (“PTP”) messages that include timestamps indicating when they were transmitted.

In additional or alternative embodiments, the first cable is a first optical fiber having a first length and the second cable is a second optical fiber having a second length. In some examples the first length is different than the second length.

Various operations of FIG. 12 may be optional. In some embodiments, blocks 1250, 1260, 1270, 1280, 1290, and 1295 are optional.

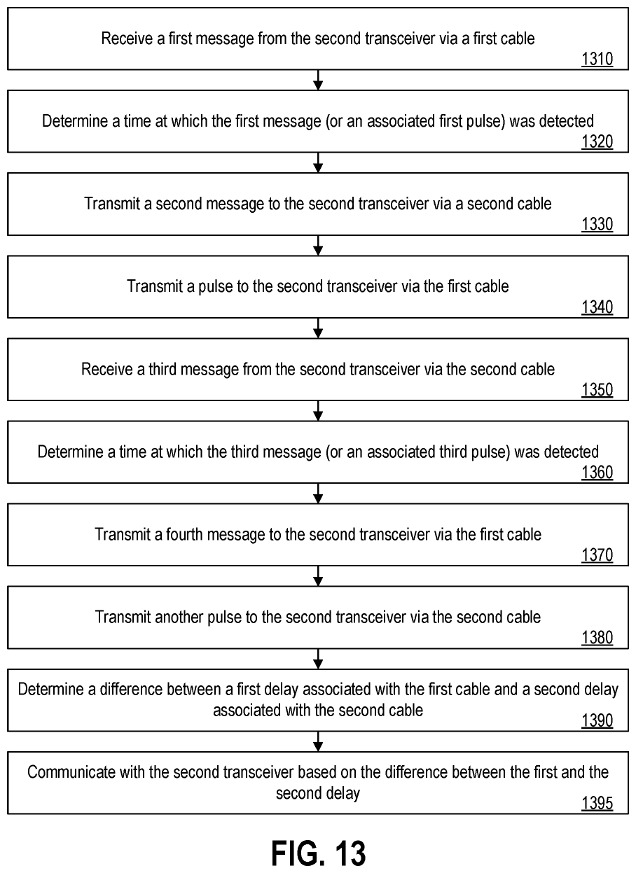

FIG. 13 illustrates an example of additional or alternative operations performed by a first transceiver communicatively coupled to a second transceiver by a first cable and a second cable.

At block 1310, processing circuitry 212 receives a first message and an associated first pulse from the second transceiver via the first cable. The first message can include an indication of a first time, T₁, associated with when the first message was transmitted by the second transceiver.

At block 1320, processing circuitry 212 determines a second time, T₂, at which the first pulse was detected.

At block 1330, processing circuitry 212 transmits a second message to the second transceiver via the second cable at a third time, T₃. The second message can include an indication of the T₂ and the T₃. In some embodiments, transmitting the second message and the associated second pulse includes: (1) generating an amplitude modulated signal including data associated with the second message using an amplitude modulator; (2) generating a transmit signal by superimposing the second pulse on the amplitude modulated signal using a phase optical modulator independent of the amplitude modulator; and (3) transmitting the transmit signal.

In additional or alternative embodiments, transmitting the second message and the associated second pulse includes: (1) applying the second pulse and a bias current that is above a laser threshold to a laser driver; (2) generating an optical signal by a laser using the laser driver; (3) generating a transmit signal by amplitude modulating the optical signal based on data associated with the second message; and (4) transmitting the transmit signal.

At block 1340, processing circuitry 212 transmits a second pulse to the second transceiver via the first cable at the T₃.

In some embodiments, receiving the first message and the associated first pulse includes receiving the first message and the associated first pulse at a first port of a circulator. Transmitting the second message and the second pulse includes passing a transmit signal including the second message and the associated second pulse through a splitter, the splitter passing the second message to the second transceiver via the second cable and passing the second pulse to a third port of the circulator.

At block 1350, processing circuitry 212 receives a third message and an associated third pulse from the second transceiver via the second cable. The third message can include an indication of a fifth time, T₅, associated with when the third message was transmitted by the second transceiver.

At block 1360, processing circuitry 212 determines a sixth time, T₆, at which the third pulse was detected.

At block 1370, processing circuitry 212 transmits a fourth message to the second transceiver via the first cable at a seventh time, T₇, the fourth message including an indication of the T₆ and the T₇. In some embodiments, the fourth message and the associated fourth pulse are transmitted in a process similar to the second message and the second pulse in block 1330.

At block 1380, processing circuitry 212 transmits a fourth pulse to the second transceiver via the second cable at the T₇.

At block 1390, processing circuitry 212 determines a difference between a first delay associated with the first cable and a second delay associated with the second cable. In some embodiments, determining the difference between the first delay and the second delay includes determining an asymmetry between at least one of: a first length of the first cable and a second length of the second cable; a first digital signal processing, DSP, time of the first transceiver and a second DSP time of the second transceiver; and a first application-specific integrated circuitry, ASIC, processing time on the first transceiver and a second ASIC processing time of the second transceiver.

At block 1395, processing circuitry 212 communicates with the second transceiver based on the difference between the first delay and the second delay.

In some embodiments, the messages (e.g., the first message and the second message) are each precise time protocol (“PTP”) messages that include timestamps indicating when they were transmitted.

In additional or alternative embodiments, the first cable is a first optical fiber having a first length and the second cable is a second optical fiber having a second length. In some examples the first length is different than the second length.

Various operations of FIG. 13 may be optional. In some embodiments, blocks 1350, 1360, 1370, 1380, 1390, and 1395 are optional.

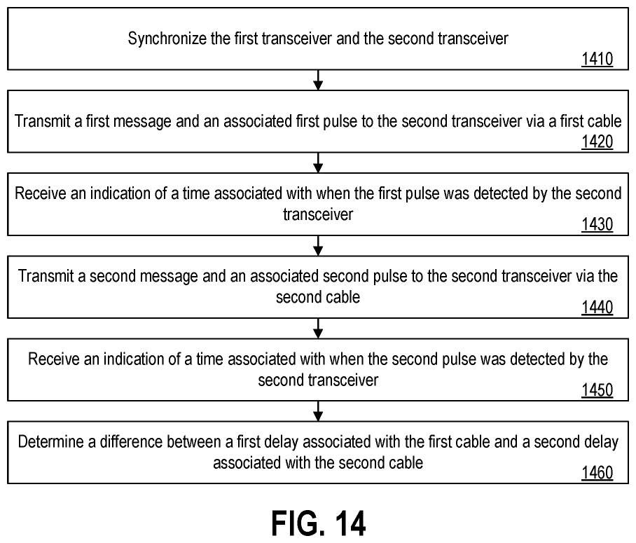

FIG. 14 illustrates an example of additional or alternative operations performed by a first transceiver communicatively coupled to a second transceiver by a first cable and a second cable.

At block 1410, processing circuitry 212 synchronizes the first transceiver and the second transceiver.

At block 1420, processing circuitry 212 transmits a first message and an associated first pulse to the second transceiver at a first time, T₁, via the first cable.

At block 1430, processing circuitry 212 receives an indication of a second time, T₂, associated with when the first pulse was detected by the second transceiver.

At block 1440, processing circuitry 212 transmits a second message and an associated second pulse to the second transceiver at a third time, T₃, via the second cable.

At block 1450, processing circuitry 212 receives an indication of a fourth time, T₄, associated with when the second pulse was detected by the second transceiver.

At block 1460, processing circuitry 212 determines a difference between a first delay associated with the first cable and a second delay associated with the second cable based on the T₁, the T₂, the T₃, and the T₄. In some embodiments, determining the difference, A, between the first delay and the second delay comprises determining A=(T₄−T₂)−(T₃−T₁).

In additional or alternative embodiments, determining the difference between the first delay and the second delay includes determining an asymmetry between at least one of: a first length of the first cable and a second length of the second cable; a first digital signal processing, DSP, time of the first transceiver and a second DSP time of the second transceiver; and a first application-specific integrated circuitry, ASIC, processing time on the first transceiver and a second ASIC processing time of the second transceiver.

In some embodiments, the messages (e.g., the first message and the second message) are each precise time protocol (“PTP”) messages that include timestamps indicating when they were transmitted.

In additional or alternative embodiments, the first cable is a first optical fiber having a first length and the second cable is a second optical fiber having a second length. In some examples the first length is different than the second length.

Various operations of FIG. 14 may be optional. In some embodiments, block 1410 is optional.

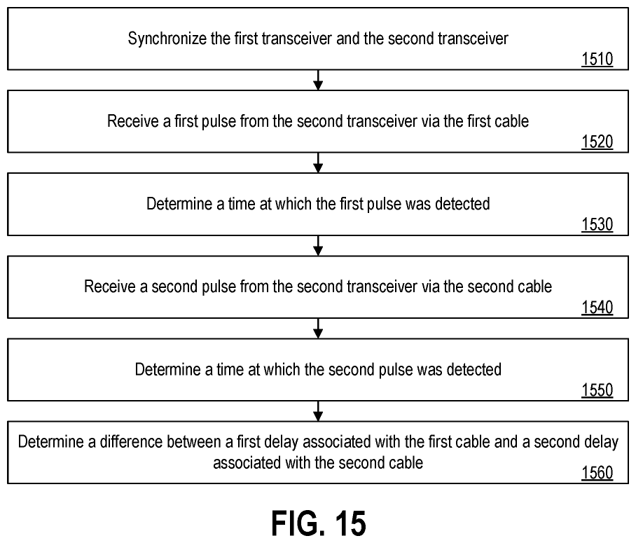

FIG. 15 illustrates an example of additional or alternative operations performed by a first transceiver communicatively coupled to a second transceiver by a first cable and a second cable.

At block 1510, processing circuitry 212 synchronizes the first transceiver and the second transceiver.

At block 1520, processing circuitry 212 receives a first pulse from the second transceiver via the first cable. The first pulse can include an indication of a first time, T₁, associated with when the first pulse was transmitted by the second transceiver.

At block 1530, processing circuitry 212 determines a second time, T₂, at which the first pulse was detected.

At block 1540, processing circuitry 212 receives a second pulse from the second transceiver via the second cable. The second pulse can include an indication of a third time, T₃, associated with when the second pulse was transmitted by the second transceiver.

At block 1550, processing circuitry 212 determines a fourth time, T₄, at which the second pulse was detected.

At block 1560, processing circuitry determines a difference between a first delay associated with the first cable and a second delay associated with the second cable based on the T₁, the T₂, the T₃, and the T₄. In some embodiments, determining the difference, A, between the first delay and the second delay includes determining A=(T₄−T₂)−(T₃−T₁).

Various operations of FIG. 15 may be optional. In some embodiments, block 1510 is optional.

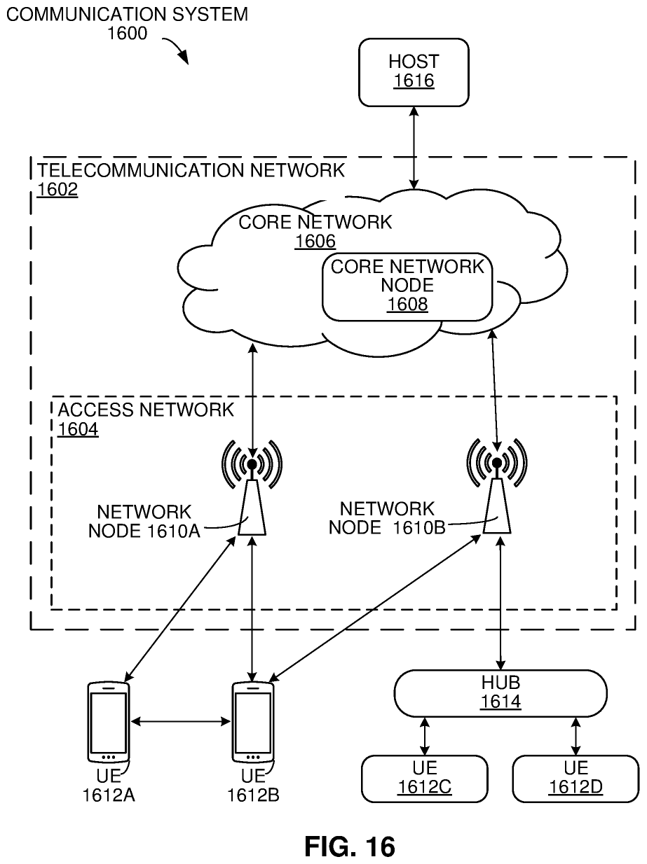

FIG. 16 shows an example of a communication system 1600 in accordance with some embodiments.

In the example, the communication system 1600 includes a telecommunication network 1602 that includes an access network 1604, such as a radio access network (RAN), and a core network 1606, which includes one or more core network nodes 1608. The access network 1604 includes one or more access network nodes, such as network nodes 1610a and 1610b (one or more of which may be generally referred to as network nodes 1610), or any other similar 3^{rd} Generation Partnership Project (3GPP) access node or non-3GPP access point. Moreover, as will be appreciated by those of skill in the art, the network nodes 1610 are not necessarily limited to an implementation in which a radio portion and a baseband portion are supplied and integrated by a single vendor. Thus, it will be understood that the network nodes 1610 may include disaggregated implementations or portions thereof. For example, in some embodiments, the telecommunication network 1602 includes one or more Open-RAN (ORAN) network nodes. An ORAN network node is a node in the telecommunication network 1602 that supports an ORAN specification (e.g., a specification published by the O-RAN Alliance, or any similar organization) and may operate alone or together with other nodes to implement one or more functionalities of any node in the telecommunication network 1602, including one or more network nodes 1610 and/or core network nodes 1608.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time RAN control application (e.g., xApp) or a non-real time RAN automation application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Intents and content-aware notifications described herein may be communicated from a 3GPP network node or an ORAN network node over 3GPP-defined interfaces (e.g., N2, N3) and/or ORAN Alliance-defined interfaces (e.g., A1, O1). Moreover, an ORAN network node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance. The network nodes 1610 facilitate direct or indirect connection of user equipment (UE), such as by connecting wireless devices 1612a, 1612b, 1612c, and 1612d (one or more of which may be generally referred to as UEs 1612) to the core network 1606 over one or more wireless connections. The network nodes 1610 facilitate direct or indirect connection of user equipment (UE), such as by connecting UEs 1612a, 1612b, 1612c, and 1612d (one or more of which may be generally referred to as UEs 1612) to the core network 1606 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1600 may include any number of wired or wireless networks, network nodes, UEs, and/or any other components or systems that may facilitate or participate in the communication of data and/or signals whether via wired or wireless connections. The communication system 1600 may include and/or interface with any type of communication, telecommunication, data, cellular, radio network, and/or other similar type of system.

The UEs 1612 may be any of a wide variety of communication devices, including wireless devices arranged, configured, and/or operable to communicate wirelessly with the network nodes 1610 and other communication devices. Similarly, the network nodes 1610 are arranged, capable, configured, and/or operable to communicate directly or indirectly with the UEs 1612 and/or with other network nodes or equipment in the telecommunication network 1602 to enable and/or provide network access, such as wireless network access, and/or to perform other functions, such as administration in the telecommunication network 1602.

In the depicted example, the core network 1606 connects the network nodes 1610 to one or more hosts, such as host 1616. These connections may be direct or indirect via one or more intermediary networks or devices. In other examples, network nodes may be directly coupled to hosts. The core network 1606 includes one more core network nodes (e.g., core network node 1608) that are structured with hardware and software components. Features of these components may be substantially similar to those described with respect to the UEs, network nodes, and/or hosts, such that the descriptions thereof are generally applicable to the corresponding components of the core network node 1608. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1616 may be under the ownership or control of a service provider other than an operator or provider of the access network 1604 and/or the telecommunication network 1602, and may be operated by the service provider or on behalf of the service provider. The host 1616 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1600 of FIG. 16 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1602 is a cellular network that implements 3GPP standardized features. Accordingly, the telecommunications network 1602 may support network slicing to provide different logical networks to different devices that are connected to the telecommunication network 1602. For example, the telecommunications network 1602 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1612 are configured to transmit and/or receive information without direct human interaction. For instance, a UE may be designed to transmit information to the access network 1604 on a predetermined schedule, when triggered by an internal or external event, or in response to requests from the access network 1604. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio—Dual Connectivity (EN-DC).

In the example, the hub 1614 communicates with the access network 1604 to facilitate indirect communication between one or more UEs (e.g., UE 1612c and/or 1612d) and network nodes (e.g., network node 1610b). In some examples, the hub 1614 may be a controller, router, content source and analytics, or any of the other communication devices described herein regarding UEs. For example, the hub 1614 may be a broadband router enabling access to the core network 1606 for the UEs. As another example, the hub 1614 may be a controller that sends commands or instructions to one or more actuators in the UEs. Commands or instructions may be received from the UEs, network nodes 1610, or by executable code, script, process, or other instructions in the hub 1614. As another example, the hub 1614 may be a data collector that acts as temporary storage for UE data and, in some embodiments, may perform analysis or other processing of the data. As another example, the hub 1614 may be a content source. For example, for a UE that is a VR headset, display, loudspeaker or other media delivery device, the hub 1614 may retrieve VR assets, video, audio, or other media or data related to sensory information via a network node, which the hub 1614 then provides to the UE either directly, after performing local processing, and/or after adding additional local content. In still another example, the hub 1614 acts as a proxy server or orchestrator for the UEs, in particular in if one or more of the UEs are low energy IoT devices.

The hub 1614 may have a constant/persistent or intermittent connection to the network node 1610b. The hub 1614 may also allow for a different communication scheme and/or schedule between the hub 1614 and UEs (e.g., UE 1612c and/or 1612d), and between the hub 1614 and the core network 1606. In other examples, the hub 1614 is connected to the core network 1606 and/or one or more UEs via a wired connection. Moreover, the hub 1614 may be configured to connect to an M2M service provider over the access network 1604 and/or to another UE over a direct connection. In some scenarios, UEs may establish a wireless connection with the network nodes 1610 while still connected via the hub 1614 via a wired or wireless connection. In some embodiments, the hub 1614 may be a dedicated hub—that is, a hub whose primary function is to route communications to/from the UEs from/to the network node 1610b. In other embodiments, the hub 1614 may be a non-dedicated hub—that is, a device which is capable of operating to route communications between the UEs and network node 1610b, but which is additionally capable of operating as a communication start and/or end point for certain data channels.

FIG. 17 shows a UE 1700 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D₂D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1700 includes processing circuitry 1702 that is operatively coupled via a bus 1704 to an input/output interface 1706, a power source 1708, a memory 1710, a communication interface 1712, and/or any other component, or any combination thereof. Certain UEs may utilize all or a subset of the components shown in FIG. 17. The level of integration between the components may vary from one UE to another UE. Further, certain UEs may contain multiple instances of a component, such as multiple processors, memories, transceivers, transmitters, receivers, etc.

The processing circuitry 1702 is configured to process instructions and data and may be configured to implement any sequential state machine operative to execute instructions stored as machine-readable computer programs in the memory 1710. The processing circuitry 1702 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1702 may include multiple central processing units (CPUs).

In the example, the input/output interface 1706 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1700. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1708 is structured as a battery or battery pack. Other types of power sources, such as an external power source (e.g., an electricity outlet), photovoltaic device, or power cell, may be used. The power source 1708 may further include power circuitry for delivering power from the power source 1708 itself, and/or an external power source, to the various parts of the UE 1700 via input circuitry or an interface such as an electrical power cable. Delivering power may be, for example, for charging of the power source 1708. Power circuitry may perform any formatting, converting, or other modification to the power from the power source 1708 to make the power suitable for the respective components of the UE 1700 to which power is supplied.

The memory 1710 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1710 includes one or more application programs 1714, such as an operating system, web browser application, a widget, gadget engine, or other application, and corresponding data 1716. The memory 1710 may store, for use by the UE 1700, any of a variety of various operating systems or combinations of operating systems.

The memory 1710 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1710 may allow the UE 1700 to access instructions, application programs and the like, stored on transitory or non-transitory memory media, to off-load data, or to upload data. An article of manufacture, such as one utilizing a communication system may be tangibly embodied as or in the memory 1710, which may be or comprise a device-readable storage medium.

The processing circuitry 1702 may be configured to communicate with an access network or other network using the communication interface 1712. The communication interface 1712 may comprise one or more communication subsystems and may include or be communicatively coupled to an antenna 1722. The communication interface 1712 may include one or more transceivers used to communicate, such as by communicating with one or more remote transceivers of another device capable of wireless communication (e.g., another UE or a network node in an access network). Each transceiver may include a transmitter 1718 and/or a receiver 1720 appropriate to provide network communications (e.g., optical, electrical, frequency allocations, and so forth). Moreover, the transmitter 1718 and receiver 1720 may be coupled to one or more antennas (e.g., antenna 1722) and may share circuit components, software or firmware, or alternatively be implemented separately.

In the illustrated embodiment, communication functions of the communication interface 1712 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1712, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1700 shown in FIG. 17.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 18 shows a network node 1800 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs), NR NodeBs (gNBs)), O-RAN nodes, or components of an O-RAN node (e.g., intelligent controller, O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1800 includes a processing circuitry 1802, a memory 1804, a communication interface 1806, and a power source 1808. The network node 1800 may be composed of multiple physically separate components (e.g., a NodeB component and a RNC component, or a BTS component and a BSC component, etc.), which may each have their own respective components. In certain scenarios in which the network node 1800 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1800 may be configured to support multiple radio access technologies (RATs). In such embodiments, some components may be duplicated (e.g., separate memory 1804 for different RATs) and some components may be reused (e.g., a same antenna 1810 may be shared by different RATs). The network node 1800 may also include multiple sets of the various illustrated components for different wireless technologies integrated into network node 1800, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1800.

The processing circuitry 1802 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1800 components, such as the memory 1804, to provide network node 1800 functionality.

In some embodiments, the processing circuitry 1802 includes a system on a chip (SOC). In some embodiments, the processing circuitry 1802 includes one or more of radio frequency (RF) transceiver circuitry 1812 and baseband processing circuitry 1814. In some embodiments, the radio frequency (RF) transceiver circuitry 1812 and the baseband processing circuitry 1814 may be on separate chips (or sets of chips), boards, or units, such as radio units and digital units. In alternative embodiments, part or all of RF transceiver circuitry 1812 and baseband processing circuitry 1814 may be on the same chip or set of chips, boards, or units.

The memory 1804 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1802. The memory 1804 may store any suitable instructions, data, or information, including a computer program, software, an application including one or more of logic, rules, code, tables, and/or other instructions capable of being executed by the processing circuitry 1802 and utilized by the network node 1800. The memory 1804 may be used to store any calculations made by the processing circuitry 1802 and/or any data received via the communication interface 1806. In some embodiments, the processing circuitry 1802 and memory 1804 is integrated.

The communication interface 1806 is used in wired or wireless communication of signaling and/or data between a network node, access network, and/or UE. As illustrated, the communication interface 1806 comprises port(s)/terminal(s) 1816 to send and receive data, for example to and from a network over a wired connection. The communication interface 1806 also includes radio front-end circuitry 1818 that may be coupled to, or in certain embodiments a part of, the antenna 1810. Radio front-end circuitry 1818 comprises filters 1820 and amplifiers 1822. The radio front-end circuitry 1818 may be connected to an antenna 1810 and processing circuitry 1802. The radio front-end circuitry may be configured to condition signals communicated between antenna 1810 and processing circuitry 1802. The radio front-end circuitry 1818 may receive digital data that is to be sent out to other network nodes or UEs via a wireless connection. The radio front-end circuitry 1818 may convert the digital data into a radio signal having the appropriate channel and bandwidth parameters using a combination of filters 1820 and/or amplifiers 1822. The radio signal may then be transmitted via the antenna 1810. Similarly, when receiving data, the antenna 1810 may collect radio signals which are then converted into digital data by the radio front-end circuitry 1818. The digital data may be passed to the processing circuitry 1802. In other embodiments, the communication interface may comprise different components and/or different combinations of components.

In certain alternative embodiments, the network node 1800 does not include separate radio front-end circuitry 1818, instead, the processing circuitry 1802 includes radio front-end circuitry and is connected to the antenna 1810. Similarly, in some embodiments, all or some of the RF transceiver circuitry 1812 is part of the communication interface 1806. In still other embodiments, the communication interface 1806 includes one or more ports or terminals 1816, the radio front-end circuitry 1818, and the RF transceiver circuitry 1812, as part of a radio unit (not shown), and the communication interface 1806 communicates with the baseband processing circuitry 1814, which is part of a digital unit (not shown).

The antenna 1810 may include one or more antennas, or antenna arrays, configured to send and/or receive wireless signals. The antenna 1810 may be coupled to the radio front-end circuitry 1818 and may be any type of antenna capable of transmitting and receiving data and/or signals wirelessly. In certain embodiments, the antenna 1810 is separate from the network node 1800 and connectable to the network node 1800 through an interface or port.

The antenna 1810, communication interface 1806, and/or the processing circuitry 1802 may be configured to perform any receiving operations and/or certain obtaining operations described herein as being performed by the network node. Any information, data and/or signals may be received from a UE, another network node and/or any other network equipment. Similarly, the antenna 1810, the communication interface 1806, and/or the processing circuitry 1802 may be configured to perform any transmitting operations described herein as being performed by the network node. Any information, data and/or signals may be transmitted to a UE, another network node and/or any other network equipment.

The power source 1808 provides power to the various components of network node 1800 in a form suitable for the respective components (e.g., at a voltage and current level needed for each respective component). The power source 1808 may further comprise, or be coupled to, power management circuitry to supply the components of the network node 1800 with power for performing the functionality described herein. For example, the network node 1800 may be connectable to an external power source (e.g., the power grid, an electricity outlet) via an input circuitry or interface such as an electrical cable, whereby the external power source supplies power to power circuitry of the power source 1808. As a further example, the power source 1808 may comprise a source of power in the form of a battery or battery pack which is connected to, or integrated in, power circuitry. The battery may provide backup power should the external power source fail.

Embodiments of the network node 1800 may include additional components beyond those shown in FIG. 18 for providing certain aspects of the network node's functionality, including any of the functionality described herein and/or any functionality necessary to support the subject matter described herein. For example, the network node 1800 may include user interface equipment to allow input of information into the network node 1800 and to allow output of information from the network node 1800. This may allow a user to perform diagnostic, maintenance, repair, and other administrative functions for the network node 1800.

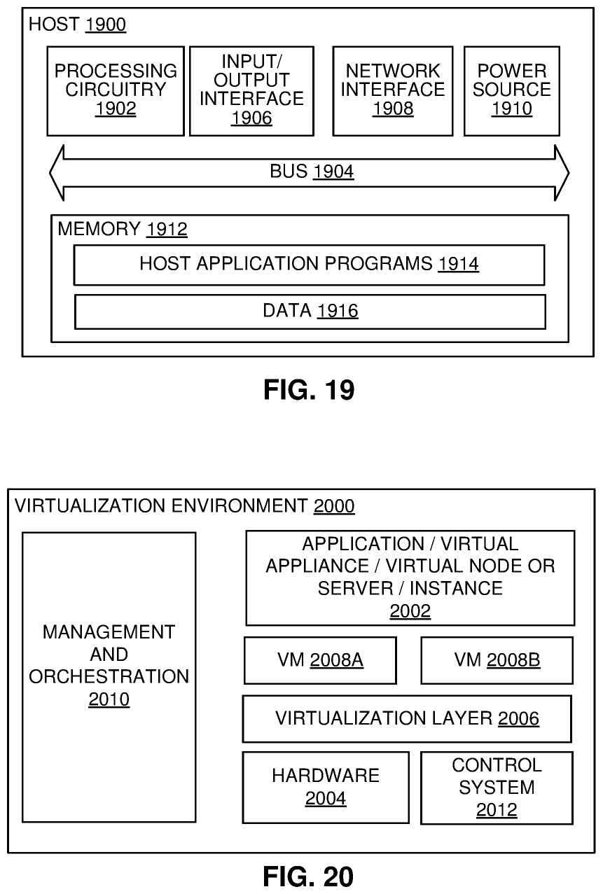

FIG. 19 is a block diagram of a host 1900, which may be an embodiment of the host 1616 of FIG. 16, in accordance with various aspects described herein. As used herein, the host 1900 may be or comprise various combinations hardware and/or software, including a standalone server, a blade server, a cloud-implemented server, a distributed server, a virtual machine, container, or processing resources in a server farm. The host 1900 may provide one or more services to one or more UEs.

The host 1900 includes processing circuitry 1902 that is operatively coupled via a bus 1904 to an input/output interface 1906, a network interface 1908, a power source 1910, and a memory 1912. Other components may be included in other embodiments. Features of these components may be substantially similar to those described with respect to the devices of previous figures, such as FIGS. 17 and 18, such that the descriptions thereof are generally applicable to the corresponding components of host 1900.

The memory 1912 may include one or more computer programs including one or more host application programs 1914 and data 1916, which may include user data, e.g., data generated by a UE for the host 1900 or data generated by the host 1900 for a UE. Embodiments of the host 1900 may utilize only a subset or all of the components shown. The host application programs 1914 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1914 may also provide for user authentication and licensing checks and may periodically report health, routes, and content availability to a central node, such as a device in or on the edge of a core network. Accordingly, the host 1900 may select and/or indicate a different host for over-the-top services for a UE. The host application programs 1914 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 20 is a block diagram illustrating a virtualization environment 2000 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 2000 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment 2000 includes components defined by the O-RAN Alliance, such as an O-Cloud environment orchestrated by a Service Management and Orchestration Framework via an O-2 interface.

Applications 2002 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 2004 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 2006 (also referred to as hypervisors or virtual machine monitors (VMMs)), provide VMs 2008a and 2008b (one or more of which may be generally referred to as VMs 2008), and/or perform any of the functions, features and/or benefits described in relation with some embodiments described herein. The virtualization layer 2006 may present a virtual operating platform that appears like networking hardware to the VMs 2008.

The VMs 2008 comprise virtual processing, virtual memory, virtual networking or interface and virtual storage, and may be run by a corresponding virtualization layer 2006. Different embodiments of the instance of a virtual appliance 2002 may be implemented on one or more of VMs 2008, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 2008 may be a software implementation of a physical machine that runs programs as if they were executing on a physical, non-virtualized machine. Each of the VMs 2008, and that part of hardware 2004 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 2008 on top of the hardware 2004 and corresponds to the application 2002.

Hardware 2004 may be implemented in a standalone network node with generic or specific components. Hardware 2004 may implement some functions via virtualization. Alternatively, hardware 2004 may be part of a larger cluster of hardware (e.g. such as in a data center or CPE) where many hardware nodes work together and are managed via management and orchestration 2010, which, among others, oversees lifecycle management of applications 2002. In some embodiments, hardware 2004 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 2012 which may alternatively be used for communication between hardware nodes and radio units.

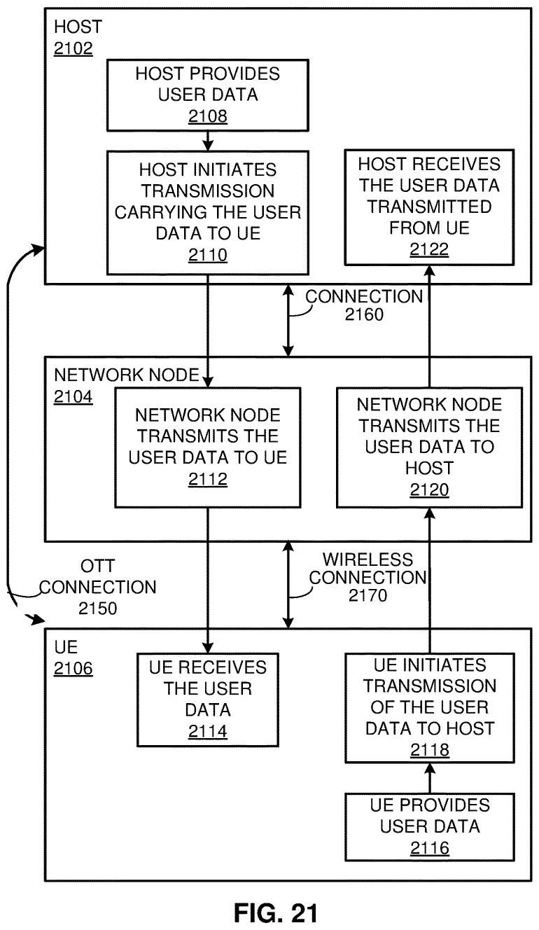

FIG. 21 shows a communication diagram of a host 2102 communicating via a network node 2104 with a UE 2106 over a partially wireless connection in accordance with some embodiments. Example implementations, in accordance with various embodiments, of the UE (such as a UE 1612a of FIG. 16 and/or UE 1700 of FIG. 17), network node (such as network node 1610a of FIG. 16 and/or network node 1800 of FIG. 18), and host (such as host 1616 of FIG. 16 and/or host 1900 of FIG. 19) discussed in the preceding paragraphs will now be described with reference to FIG. 21.

Like host 1900, embodiments of host 2102 include hardware, such as a communication interface, processing circuitry, and memory. The host 2102 also includes software, which is stored in or accessible by the host 2102 and executable by the processing circuitry. The software includes a host application that may be operable to provide a service to a remote user, such as the UE 2106 connecting via an over-the-top (OTT) connection 2150 extending between the UE 2106 and host 2102. In providing the service to the remote user, a host application may provide user data which is transmitted using the OTT connection 2150.

The network node 2104 includes hardware enabling it to communicate with the host 2102 and UE 2106. The connection 2160 may be direct or pass through a core network (like core network 1606 of FIG. 16) and/or one or more other intermediate networks, such as one or more public, private, or hosted networks. For example, an intermediate network may be a backbone network or the Internet.

The UE 2106 includes hardware and software, which is stored in or accessible by UE 2106 and executable by the UE's processing circuitry. The software includes a client application, such as a web browser or operator-specific “app” that may be operable to provide a service to a human or non-human user via UE 2106 with the support of the host 2102. In the host 2102, an executing host application may communicate with the executing client application via the OTT connection 2150 terminating at the UE 2106 and host 2102. In providing the service to the user, the UE's client application may receive request data from the host's host application and provide user data in response to the request data. The OTT connection 2150 may transfer both the request data and the user data. The UE's client application may interact with the user to generate the user data that it provides to the host application through the OTT connection 2150.

The OTT connection 2150 may extend via a connection 2160 between the host 2102 and the network node 2104 and via a wireless connection 2170 between the network node 2104 and the UE 2106 to provide the connection between the host 2102 and the UE 2106. The connection 2160 and wireless connection 2170, over which the OTT connection 2150 may be provided, have been drawn abstractly to illustrate the communication between the host 2102 and the UE 2106 via the network node 2104, without explicit reference to any intermediary devices and the precise routing of messages via these devices.

As an example of transmitting data via the OTT connection 2150, in step 2108, the host 2102 provides user data, which may be performed by executing a host application. In some embodiments, the user data is associated with a particular human user interacting with the UE 2106. In other embodiments, the user data is associated with a UE 2106 that shares data with the host 2102 without explicit human interaction. In step 2110, the host 2102 initiates a transmission carrying the user data towards the UE 2106. The host 2102 may initiate the transmission responsive to a request transmitted by the UE 2106. The request may be caused by human interaction with the UE 2106 or by operation of the client application executing on the UE 2106. The transmission may pass via the network node 2104, in accordance with the teachings of the embodiments described throughout this disclosure. Accordingly, in step 2112, the network node 2104 transmits to the UE 2106 the user data that was carried in the transmission that the host 2102 initiated, in accordance with the teachings of the embodiments described throughout this disclosure. In step 2114, the UE 2106 receives the user data carried in the transmission, which may be performed by a client application executed on the UE 2106 associated with the host application executed by the host 2102.

In some examples, the UE 2106 executes a client application which provides user data to the host 2102. The user data may be provided in reaction or response to the data received from the host 2102. Accordingly, in step 2116, the UE 2106 may provide user data, which may be performed by executing the client application. In providing the user data, the client application may further consider user input received from the user via an input/output interface of the UE 2106. Regardless of the specific manner in which the user data was provided, the UE 2106 initiates, in step 2118, transmission of the user data towards the host 2102 via the network node 2104. In step 2120, in accordance with the teachings of the embodiments described throughout this disclosure, the network node 2104 receives user data from the UE 2106 and initiates transmission of the received user data towards the host 2102. In step 2122, the host 2102 receives the user data carried in the transmission initiated by the UE 2106.

One or more of the various embodiments improve the performance of OTT services provided to the UE 2106 using the OTT connection 2150, in which the wireless connection 2170 forms the last segment. More precisely, the teachings of these embodiments may allow for differential delay impairment to be actively monitored without impacting traffic without adding any additional instrument for delay measurement.

In an example scenario, factory status information may be collected and analyzed by the host 2102. As another example, the host 2102 may process audio and video data which may have been retrieved from a UE for use in creating maps. As another example, the host 2102 may collect and analyze real-time data to assist in controlling vehicle congestion (e.g., controlling traffic lights). As another example, the host 2102 may store surveillance video uploaded by a UE. As another example, the host 2102 may store or control access to media content such as video, audio, VR or AR which it can broadcast, multicast or unicast to UEs. As other examples, the host 2102 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 2150 between the host 2102 and UE 2106, in response to variations in the measurement results. The measurement procedure and/or the network functionality for reconfiguring the OTT connection may be implemented in software and hardware of the host 2102 and/or UE 2106. In some embodiments, sensors (not shown) may be deployed in or in association with other devices through which the OTT connection 2150 passes; the sensors may participate in the measurement procedure by supplying values of the monitored quantities exemplified above, or supplying values of other physical quantities from which software may compute or estimate the monitored quantities. The reconfiguring of the OTT connection 2150 may include message format, retransmission settings, preferred routing etc.; the reconfiguring need not directly alter the operation of the network node 2104. Such procedures and functionalities may be known and practiced in the art. In certain embodiments, measurements may involve proprietary UE signaling that facilitates measurements of throughput, propagation times, latency and the like, by the host 2102. The measurements may be implemented in that software causes messages to be transmitted, in particular empty or ‘dummy’ messages, using the OTT connection 2150 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

The invention claimed is:

1. A method of operating a first transceiver communicatively coupled to a second transceiver by a first cable and a second cable, the method comprising:
transmitting a first message to the second transceiver at a first time, T₁, via the first cable;
receiving a second message from the second transceiver via the second cable, the second message including an indication of a second time, T₂,
receiving an optical pulse associated with the second message transmitted by the second transceiver; wherein the second message includes an indication of a third time, T₃, at which the optical pulse was transmitted;
wherein the receiving the optical pulse associated with the second message from the second transceiver is via the first cable and at a fourth time, T₄; and
determining a first delay associated with the first cable based on the determined values of T₁, the T₂, the T₃, and the T₄.

2. The method of claim 1, wherein determining the first delay associated with the first cable comprises determining the first delay, D₁, based on
$${D}_{1} = [ ( {T}_{4} - {T}_{1} ) - ( {T}_{3} - {T}_{2} ) ] / 2.$$

3. The method of claim 1, wherein the T₂ is a time associated with when the first message was detected by the second transceiver.

4. The method of claim 1, wherein the pulse is a second pulse,
wherein transmitting the first message comprises transmitting the first message and an associated first optical pulse to the second transceiver at the T₁ via the first cable, and
wherein the T₂ is a time associated with when the first optical pulse was detected by the second transceiver.

5. The method of claim 4, wherein transmitting the first message and the associated first optical pulse comprises:
generating an amplitude modulated signal including data associated with the first message using an amplitude modulator;
generating a transmit signal by superimposing the first optical pulse on the amplitude modulated signal using a phase optical modulator independent of the amplitude modulator; and
transmitting the transmit signal.

6. The method of claim 4, wherein transmitting the first message and the associated first optical pulse comprises:
applying the first optical pulse and a bias current that is above a laser threshold to a laser driver;
generating an optical signal by a laser using the laser driver;
generating a transmit signal by amplitude modulating the optical signal based on data associated with the first message; and
transmitting the transmit signal.

7. The method of claim 1, further comprising:
transmitting a third message to the second transceiver at a fifth time, T₅, via the second cable;
receiving a fourth message from the second transceiver via the first cable, the fourth message including an indication of a sixth time, T₆, and an indication of a seventh time, T₇, associated with when a fourth optical pulse that is associated with the fourth message was transmitted by the second transceiver;
receiving the fourth optical pulse associated with the fourth message from the second transceiver at an eighth time, T₈, via the second cable;
determining a second delay associated with the second cable based on the T₅, the T₆, the T₇, and the T₈; and
determining a difference between the first delay and the second delay.

8. The method of claim 7, wherein determining the second delay associated with the second cable comprises determining the second delay, D₂, based on
$${D}_{2} = [ ( {T}_{8} - {T}_{5} ) - ( {T}_{7} - {T}_{6} ) ] / 2.$$

9. The method of claim 7, wherein the T₆ is a time associated with when the third message was detected by the second transceiver.

10. The method of claim 7, wherein the optical pulse is a second pulse,
wherein transmitting the third message comprises transmitting the third message and an associated third optical pulse to the second transceiver at the T₅ via the second cable, and
wherein the T₆ is a time associated with when the third optical pulse was detected by the second transceiver.

11. The method of claim 7, further comprising:
communicating with the second transceiver based on the difference between the first delay and the second delay.

12. The method of claim 7, wherein determining the difference between the first delay and the second delay comprises determining an asymmetry between at least one of:
a first length of the first cable and a second length of the second cable;
a first digital signal processing, DSP, time of the first transceiver and a second DSP time of the second transceiver; and
a first application-specific integrated circuitry, ASIC, processing time on the first transceiver and a second ASIC processing time of the second transceiver.

13. The method of claim 1, further comprising:
receiving a fifth message and an associated fifth pulse from the second transceiver via the first cable, the fifth message including an indication of a ninth time, T₉, associated with when the fifth message was transmitted by the second transceiver;
determining a tenth time, T₁₀, at which the fifth optical pulse was detected;
transmitting a sixth message to the second transceiver via the second cable at a eleventh time, T₁₁, the sixth message including an indication of the T₁₀ and the T₁₁;
transmitting a sixth optical pulse to the second transceiver via the first cable at the T₁₁;
receiving a seventh message and an associated seventh pulse from the second transceiver via the second cable, the seventh message including an indication of a twelfth time, T₁₂, associated with when the seventh message was transmitted by the second transceiver;
determining a thirteenth time, T₁₃, at which the seventh optical pulse was detected;
transmitting an eighth message to the second transceiver via the first cable at a fourteenth time, T₁₄, the eighth message including an indication of the T₁₃ and the T₁₄; and
transmitting an eighth pulse to the second transceiver via the second cable at the T₁₄.

14. The method of claim 1, further comprising:
receiving a fifth message from the second transceiver via the first cable, the fifth message including an indication of a ninth time, T₉, associated with when the fifth message was transmitted by the second transceiver;
determining a tenth time, T₁₀, at which the fifth message was detected;
transmitting a sixth message to the second transceiver via the second cable at a eleventh time, T₁₁, the sixth message including an indication of the T₁₀ and the T₁₁;
transmitting a sixth optical pulse to the second transceiver via the first cable at the T₁₁;
receiving a seventh message from the second transceiver via the second cable, the seventh message including an indication of a twelfth time, T₁₂, associated with when the seventh message was transmitted by the second transceiver;
determining a thirteenth time, T₁₃, at which the seventh message was detected;
transmitting an eighth message to the second transceiver via the first cable at a fourteenth time, T₁₄, the eighth message including an indication of the T₁₃ and the T₁₄; and
transmitting an eighth pulse to the second transceiver via the second cable at the T₁₄.

15. The method of claim 14, wherein receiving the fifth message and the associated fifth optical pulse comprises receiving the fifth message and the associated fifth pulse at a first port of a circulator, and
wherein transmitting the sixth message and the sixth optical pulse comprises passing a transmit signal including the sixth message and the associated sixth optical pulse through a splitter, the splitter passing the sixth message to the second transceiver and passing the sixth optical pulse to a third port of the circulator.

16. The method of claim 1, wherein the first message and the second message are each precise time protocol, PTP, messages, and
wherein the first message includes a first timestamp indicating the T₁.

17. The method of claim 1, wherein the first cable is a first optical fiber having a first length, and
wherein the second cable is a second optical fiber having a second length.

18. The method of claim 17, wherein the first length is different than the second length.

19-37. (canceled)
